(19) United States
(12) Patent Application Publication
(10) Pub. No.: US 2023/0247702 A1
(43) Pub. Date: Aug. 3, 2023

(54) EMLMR LINK INDICATION FOR ENHANCED MULT-LINK MULTI-RADIO OPERATIONS AND TXOP PROTECTION IN QUICK RECOVERY FOR MLO

(71) Applicant: Samsung Electronics Co., Ltd., Suwon-si (KR)

(72) Inventors: Rubayet Shafin, Allen, TX (US); Boon Loong Ng, Plano, TX (US); Ahmed Atef Ibrahim Ibrahim, Plano, TX (US)

(21) Appl. No.: 18/160,275

(22) Filed: Jan. 26, 2023

Related U.S. Application Data
(60) Provisional application No. 63/304,385, filed on Jan. 28, 2022.
(60) Provisional application No. 63/311,768, filed on Feb. 18, 2022.

(51) Int. Cl. H04W 76/15; H04W 76/11

(52) U.S. Cl. CPC H04W 76/15; H04W 76/11

(57) ABSTRACT

Methods and apparatuses for facilitating the indication of links of a multi-link device (MLD) that are configured for enhanced multi-link multi-radio (EMLMR) operation in a wireless local area network (WLAN). A non-access point (AP) MLD comprises STAs, each comprising a transceiver configured to form a link with a corresponding AP of an AP MLD, and a processor operably coupled to the STAs. At least a subset of the links are EMLMR links configured to operate in an EMLMR mode of operation. The processor is configured to generate a message including an indication that the subset of the links are EMLMR links. At least one of the transceivers is further configured to transmit, to the AP MLD, the message before an EMLMR frame exchange.

### CROSS-REFERENCE TO RELATED APPLICATION AND CLAIM OF PRIORITY

This application claims priority under 35 U.S.C. § 119(e) to U.S. Provisional Patent Application No. 63/304,385 filed on Jan. 28, 2022, which is hereby incorporated by reference in their entirety.

### TECHNICAL FIELD

This disclosure relates generally to transmission efficiency in wireless communications systems that include multi-link devices. Embodiments of this disclosure relate to methods and apparatuses for facilitating the indication of links of a multi-link device that are configured for enhanced multi-link multi-radio operation, and for preserving a transmission opportunity for a quick recovery link of a multi-link device in a wireless local area network communications system.

### BACKGROUND

Wireless local area network (WLAN) technology allows devices to access the internet in the 2.4 GHz, 5 GHz, 6 GHz, or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

Next generation extremely high throughput (EHT) WI-FI systems, e.g., IEEE 802.11be, support multiple bands of operation, called links, over which an access point (AP) and a non-AP device can communicate with each other. Thus both the AP and non-AP device may be capable of communicating on different bands/links, which is referred to as multi-link operation (MLO). The WI-FI devices that support MLO are referred to as multi-link devices (MLDs). With MLO, it is possible for a non-access point (non-AP) MLD to discover, authenticate, associate, and set up multiple links with an AP MLD. Channel access and frame exchange is possible on each link that is set up between the AP MLD and non-AP MLD. The component of an MLD that is responsible for transmission and reception on one link is referred to as a station (STA).

The non-AP MLDs in 802.11be can have different capabilities in terms of multi-link operation. The current specification defines two special kinds of multi-link operations, namely, Enhanced Multi-Link Single-Radio Operation (EMLSR) and Enhanced Multi-Link Multi-Radio Operation (EMLMR).

Many 802.11be non-AP MLDs may only have a single radio. EMLSR enables a multi-link operation with a single radio. With EMLSR operation, such a non-AP MLD can achieve throughput enhancement with reduced latency—a performance close to concurrent dual radio non-AP MLDs. EMLSR mode may also be implemented on multi-radio MLDs to improve channel access capability with limited hardware cost and power consumption or to improve spectral efficiency. In EMLSR mode, a multi-radio non-AP device behaves like a single radio device that can perform channel sensing and reception of elementary packets on multiple bands/links simultaneously but can perform reliable data communication on only one link at a time. Thus, by opportunistically selecting a link for data communication where it wins the channel contention, EMLSR can improve system spectral efficiency.

EMLMR operation is another mode of operation newly defined in the IEEE 802.11be specification. With the EMLMR mode of operation, it is possible for an MLD with multiple radios to move transmit (TX)/receive (RX) chains from one link (e.g., a first link) to another link (e.g., a second link) of the same MLD, essentially increasing the spatial stream capability of the second link.

Block Acknowledgment (BA) is one of the major features that enable aggregation of multiple MAC Protocol Data Units (MPDUs) using one Aggregated MAC Protocol Data Unit (A-MPDU). With BA capability, multiple MPDUs in one A-MPDU can be acknowledged together in a single BA. The IEEE 802.11 baseline standard defines a protected BA mechanism whereby scoreboard context can only be updated using a robust Add Block ACK (ADDBA) Request frame that updates WinStart_{B} and WinSize_{B}, where a Block ACK Request (BAR) frame is only used to indicate reception status. The recipient advances the windows after validation and responds with a robust ADDBA Response frame. After the handshake is complete, the originator updates its windows (WinStart_{O} and WinSize_{O}) accordingly. The reason is that ADDBA Request and ADDBA Response frames are management frames that can be protected, while control frames such as the BAR frame cannot be protected. Hence, BAR is not robust against attacks that may interfere with the reorder buffer by changing buffer windows.

Multi-link Block Acknowledgement (ML-BA) is another key feature that is introduced for EHT WI-FI systems, whereby a BA can be sent on any enabled link between MLDs as long as the same traffic identifier (TID) is mapped to the link that carries the BA and the link that carries the related data, e.g., Quality of Service (QoS) data.

### SUMMARY

Embodiments of the present disclosure provide methods and apparatuses for facilitating the indication of links of an MLD that are configured for EMLMR operation, and for preserving a transmission opportunity (TXOP) for a quick recovery link of an MLD in a WLAN.

In one embodiment, a non-AP MLD is provided, comprising STAs and a processor operably coupled to the STAs. The STAs each comprise a transceiver configured to form a link with a corresponding AP of an AP MLD. At least a subset of the links are EMLMR links configured to operate in an EMLMR mode of operation. The processor is configured to generate a message including an indication that the subset of the links are EMLMR links. At least one of the transceivers is further configured to transmit, to the AP MLD, the message before an EMLMR frame exchange.

In another embodiment, an AP MLD is provided, comprising APs and a processor operably coupled to the APs. The APs each comprise a transceiver configured to form a link with a corresponding STA of a non-AP MLD. At least one of the transceivers is configured to receive, from the non-AP MLD, a message including an indication that at least a subset of the links are EMLMR links configured to operate in an EMLMR mode of operation. The processor is configured to select one of the EMLMR links on which to initiate an EMLMR frame exchange.

In another embodiment, a method of wireless communication is provided, performed by a non-AP MLD that comprises STAs that each comprise a transceiver configured to form a link with a corresponding AP of an AP MLD, at least a subset of the links being EMLMR links configured to operate in an EMLMR mode of operation. The method includes the steps of generating a message including an indication that the subset of the links are EMLMR links, and transmitting, to the AP MLD, the message before an EMLMR frame exchange.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example of transitioning into EMLSR operation according to embodiments of the present disclosure;

FIG. 4 illustrates an example of EMLMR operation according to embodiments of the present disclosure;

FIG. 5 illustrates an example of EMLMR operation when all links are treated as EMLMR links according to embodiments of the present disclosure;

FIG. 6 illustrates an example format of the EML Control field including an EMLMR Link Bitmap subfield according to embodiments of the present disclosure;

FIG. 7 illustrates an example of explicitly indicating EMLMR links for EMLMR frame exchanges according to embodiments of the present disclosure;

FIG. 8 illustrates an example format of the EML Control field including the EMLMR Link Bitmap subfield and the EMLMR Link Bitmap Present subfield according to embodiments of the present disclosure;

FIG. 9 illustrates an example format of the EML Control field including both the EMLSR Link Bitmap Present subfield and the EMLMR Link Bitmap Present subfield according to embodiments of the present disclosure;

FIG. 10 illustrates another example format of the EML Control field according to embodiments of the present disclosure;

FIG. 11 illustrates another example format of the EML Control field according to embodiments of the present disclosure;

FIG. 12 illustrates an example process using the EMLMR Link Bitmap subfield in order to indicate the EMLMR links according to embodiments of the present disclosure;

FIG. 13 illustrates an example format of the EML Capabilities subfield of the Common Info field of the Basic Multi-Link element according to embodiments of the present disclosure;

FIG. 14 illustrates an example of single-link BA agreement setup, data transfer, and acknowledgement according to embodiments of the present disclosure;

FIG. 15 illustrates an example of Quick Recovery mode operation for MLO according to embodiments of the present disclosure;

FIG. 16A illustrates an example timing for A-MPDU transmission using ML-BA without QR mode operation according to embodiments of the present disclosure;

FIG. 16B illustrates an example timing for A-MPDU transmission using ML-BA with QR mode operation according to embodiments of the present disclosure; and

FIG. 17 illustrates an example process for facilitating the indication of links of an MLD that are configured for EMLMR operation according to various embodiments of the present disclosure.

### DETAILED DESCRIPTION

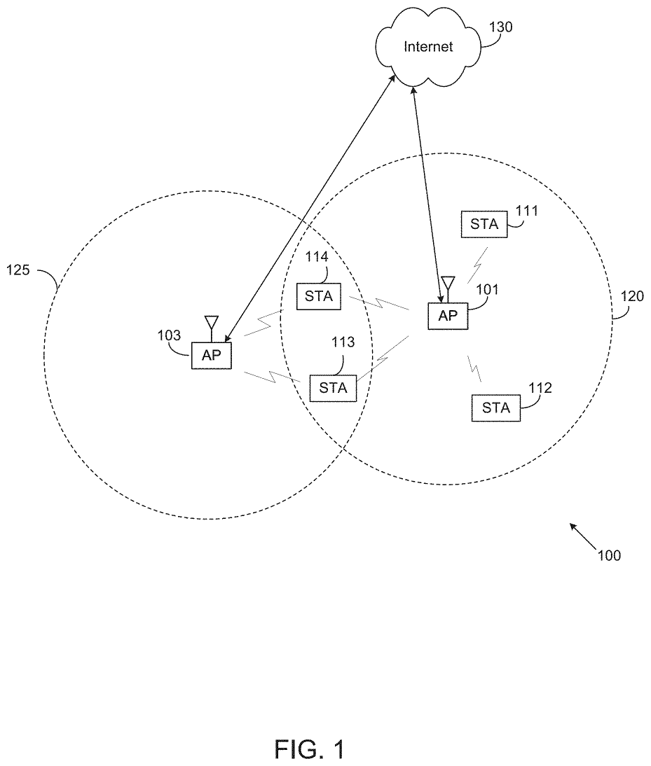

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

An AP MLD and a non-AP MLD may exchange EML Operating Mode Notification frames in order to transition into an EMLMR mode of operation, in a manner similar to that used to transition into the EMLSR mode of operation. Embodiments of the present disclosure recognize that after the non-AP MLD transitions into EMLMR mode, it is the AP MLD that sends an Initial Frame to the non-AP MLD to initiate an EMLMR frame exchange, and according to the current specification, the AP MLD, for EMLMR frame exchanges, shall select one of the links that are included as the EMLMR links.

Embodiments of the present disclosure further recognize that there is currently no mechanism to indicate the EMLMR links and exchange this information between the AP MLD and the non-AP MLD supporting the EMLMR operation. Without an indication of the EMLMR links from the non-AP MLD, it is not possible for the AP MLD to know on which link to send the initial control frame to initiate the EMLMR frame exchanges. Accordingly, embodiments of the present disclosure provide methods and apparatuses to facilitate EMLMR operation between an AP MLD and a non-AP MLD by providing mechanisms for exchanging information indicating which links are the EMLMR links.

Embodiments of the present disclosure further recognize that Multi-Link Block-Acknowledgment (ML-BA) operation was introduced to utilize MLO as follows: ML-BA uses a single common buffer for all enabled links that have the same TID mapped to them and A-MPDUs for all links are pulled from the common buffer with continuous sequence number (SN). ML-BA brings benefits over non-ML BA for large buffer data as it allows transmission of the BA on any of the enabled links, not just on the link that carries the QoS Data (i.e., the A-MPDU). However, only marginal gains over non-ML BA can be achieved if instantaneous communication between STAs is possible. This is because retransmission of failed MPDUs of the A-MPDU is allowed on any of the enabled links that have the same TIDs mapped to them, and the retransmission will not start until the ML-BA is received by the originator, which is after the A-MPDU and BAR are received by the recipient and the scoreboard is updated based on received BA at the originator. Therefore, MLO may not be utilized efficiently to enhance retransmission compared to single-link BA operation, especially if a single link is used for QoS data transmission (where BA is discouraged due to retransmission latency) and if increased size of A-MPDU is used (for example, 512 and 1024 subframes are now possible in 802.11be).

Embodiments of the present disclosure further recognize that a Quick Recovery (QR or QC) mode of operation may be defined for use with ML-BA, utilizing two or more links between two or more MLDs for a single A-MPDU—e.g., a data link (DL) that carries QoS data from originator to recipient and a quick recovery link (QRL or QCL) that carries a failed MPDU indication from recipient to originator and carries the retransmission of the one or more failed MPDUs from the originator to the recipient. Therefore, TXOPs on both links are utilized for a single A-MPDU transmission as opposed to transmitting two or more different A-MPDUs on the same links.

The QR mode of operation can enable a recipient MLD to transmit a notification to the originator of a failed MPDU on a second link that is different from the first link that carries the QoS data, thereby enabling the originator MLD to retransmit the failed MPDU on any of the enabled links that are different from the first link even if the QoS data A-MPDU is still being transmitted. In some embodiments, the QR mode can reserve two links, where one of the links (e.g., the DL) carries the QoS data and the other link (e.g., the QRL or QCL) is kept on hold waiting for any failed MPDU notification to retransmit.

Embodiments of the present disclosure further recognize that reserving a second link as the QRL for the purposes of retransmission will leave the second link idle most of the time, waiting for any failed MPDU notification to retransmit. Accordingly, the QCL may lose channel access as it is silent for most of the TXOP and only active when it is retransmitting failed MPDUs from the other link. Accordingly, embodiments of the present disclosure provide methods and apparatuses that allow an MLD to avoid losing the TXOP on the quick recovery link, which handles intermediate retransmission in the quick recovery mode in MLO.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of STAs 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating recovery from loss of medium synchronization for MLDs and renegotiating TID-to-link mapping for EMLSR operation for MLDs in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

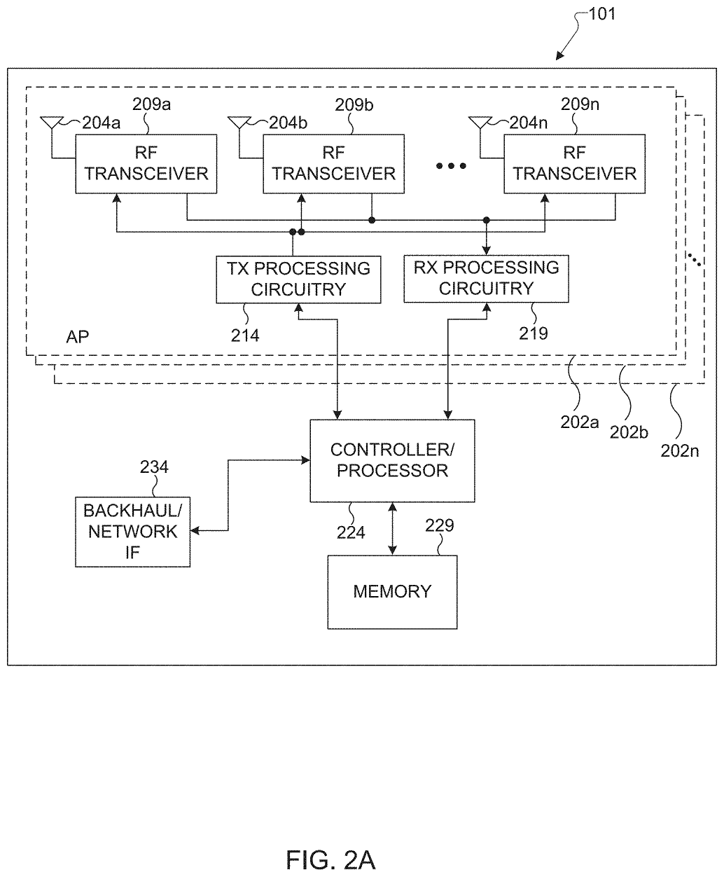

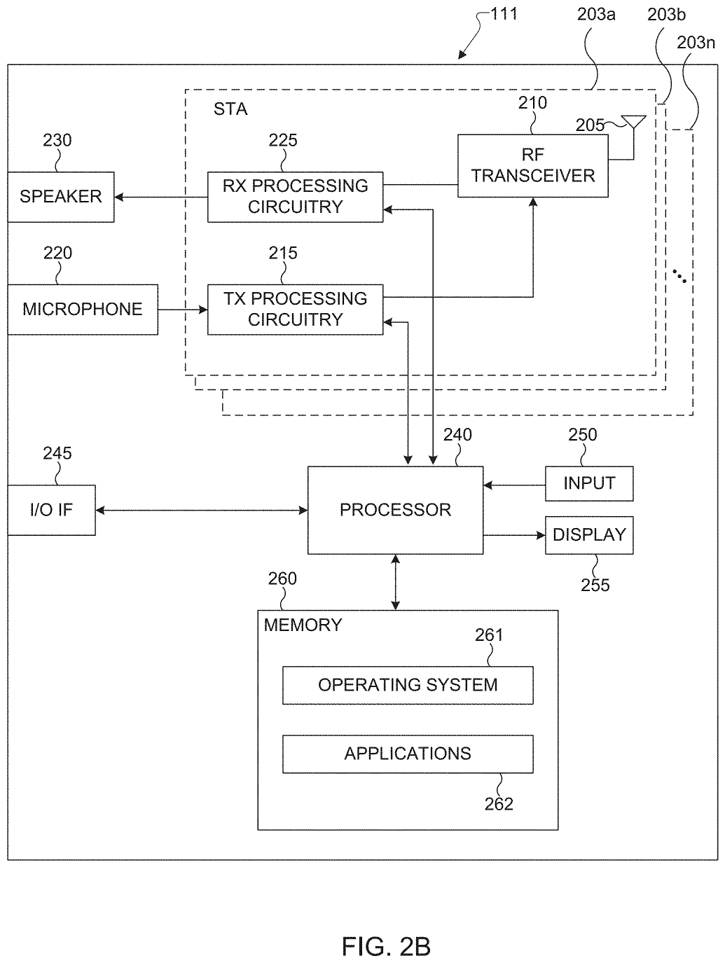

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed herein below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP MLD 101 by the controller/processor 224 including facilitating recovery from loss of medium synchronization for MLDs and renegotiating TID-to-link mapping for EMLSR operation for MLDs in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating recovery from loss of medium synchronization for MLDs and renegotiating TID-to-link mapping for EMLSR operation for MLDs in WLANs. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed herein below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate recovery from loss of medium synchronization for MLDs and renegotiating TID-to-link mapping for EMLSR operation for MLDs in WLANs. In some embodiments, the controller/processor 240 includes at least one microprocessor or microcontroller.

The controller/processor 240 is also capable of executing other processes and programs resident in the memory 260, such as operations for facilitating recovery from loss of medium synchronization for MLDs and renegotiating TID-to-link mapping for EMLSR operation for MLDs in WLANs. The controller/processor 240 can move data into or out of the memory 260 as required by an executing process. In some embodiments, the controller/processor 240 is configured to execute a plurality of applications 262, such as applications for facilitating recovery from loss of medium synchronization for MLDs and renegotiating TID-to-link mapping for EMLSR operation for MLDs in WLANs. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

EMLSR operation and the behavior of STAs affiliated with a non-AP MLD during EMLSR mode operation are defined in 802.11be standards. According to current specifications, if a non-AP MLD intends to operate in EMLSR mode with its associated AP MLD, a STA affiliated with the non-AP MLD sends an EML Operating Mode Notification frame (EOMNF) to its associated AP affiliated with the AP MLD with the EMLSR Mode subfield in the EML Control field of the frame set to 1, to its associated AP affiliated with the AP MLD.

Upon receiving the EML Operating Mode Notification frame from the non-AP MLD, the AP MLD can send, on any enabled link between the AP MLD and the non-AP MLD, another EML Operating Mode Notification frame with the EMLSR Mode subfield in the EML Control field of the frame set to 1. The AP affiliated with the AP MLD is expected to send the EML Operating Mode Notification frame in response to the EML Operating Mode Notification frame sent by a STA affiliated with the non-AP MLD within the timeout interval indicated in the Transition Timeout subfield in the EML Capabilities subfield in the Basic Variant Multi-Link element that is most recently exchanged between the AP MLD and the non-AP MLD.

The non-AP MLD transitions to EMLSR mode immediately after receiving the EML Operating Mode Notification frame with EMLSR Mode subfield in EML Control field set to 1 from an AP affiliated with the AP MLD, or immediately after the timeout interval indicated in the Transition Timeout subfield in the EML Capabilities field in the Basic Variant Multi-Link element elapses after the end of the last PPDU contained in the EML Operating Mode Notification frame transmitted by the non-AP MLD—whichever occurs first. Upon transitioning into the EMLSR mode of operation, all STAs affiliated with the non-AP MLD transition to active mode (or listening mode).

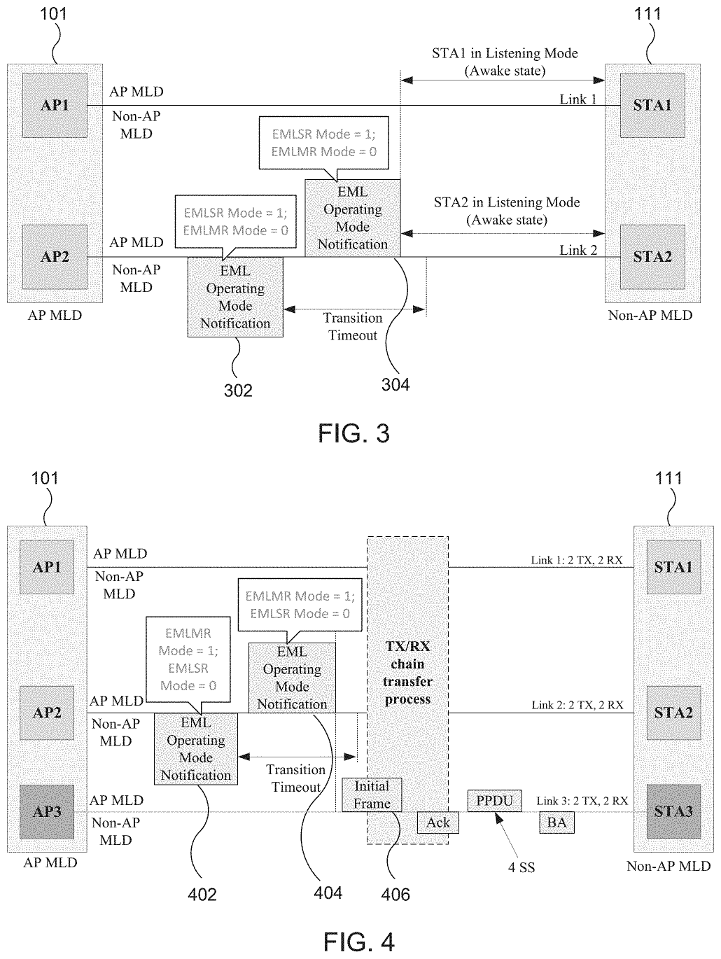

FIG. 3 illustrates an example of transitioning into EMLSR operation according to embodiments of the present disclosure. In this example, the AP MLD may be an AP MLD 101, and the non-AP MLD may be a non-AP MLD 111. Although the AP MLD 101 is illustrated with two affiliated APs (AP1 and AP2) and the non-AP MLD 111 is illustrated as a single radio non-AP MLD with two affiliated non-AP STAs (STA1 and STA2), it is understood that this process could be applied with suitable MLDs having any number of affiliated APs or STAs. For ease of explanation, it is understood that references to an AP MLD and a non-AP MLD in further embodiments below refer to the AP MLD 101 and non-AP MLD 111, respectively.

In the example of FIG. 3, two links are set up between the AP MLD and the non-AP MLD—Link 1 between AP1 and STA1, and Link 2 between AP2 and STA2. Moreover, in this illustration, both Link 1 and Link 2 are enabled links. The non-AP MLD intends to transition to EMLSR mode, and accordingly STA2 sends to AP2 over Link 2 an EML Operating Mode Notification frame 302 with EMLSR Mode subfield in EML Control field set to 1. In response to the EML Operating Mode Notification frame 302 transmitted by the non-AP MLD, AP2 sends to STA2 another EML Operating Mode Notification frame 304 with EMLSR Mode subfield in EML Control field set to 1. After receiving the EML Operating Mode Notification frame 304 from the AP MLD, the non-AP MLD transitions into EMLSR mode, and both STA1 and STA2 transition into listening mode.

The operating procedure for a non-AP MLD in EMLMR mode is also defined in 802.11be standards. According to the current specification, the procedure for a non-AP MLD to transition into EMLMR mode is quite similar to the procedure for transitioning into EMLSR mode. If a non-AP MLD intends to operate in EMLMR mode with its associated AP MLD, a STA affiliated with the non-AP MLD sends an EML Operating Mode Notification frame to its associated AP affiliated with the AP MLD, with the EMLMR Mode subfield in the EML Control field in the EML Operating Mode Notification frame set to 1 (and with the EMLSR Mode subfield in the same frame set to 0).

Upon receiving the EML Operating Mode Notification frame from the non-AP MLD, the AP MLD can send, on any enabled link between the AP MLD and the non-AP MLD, another EML Operating Mode Notification frame with the EMLMR Mode subfield in the EML Control field in the EML Operating Mode Notification frame set to 1. The AP affiliated with the AP MLD is expected to send the EML Operating Mode Notification frame in response to the EML Operating Mode Notification frame sent by the STA affiliated with the non-AP MLD within the timeout interval indicated in the Transition Timeout subfield in EML Capabilities subfield in the Basic Variant Multi-Link element that is most recently exchanged between the AP MLD and the non-AP MLD.

The non-AP MLD transitions to EMLMR mode immediately after receiving the EML Operating Mode Notification frame with EMLMR Mode subfield in EML Control field set to 1 from an AP affiliated with the AP MLD, or immediately after the timeout interval indicated in the Transition Timeout subfield in EML Capabilities field in the Basic Variant Multi-Link element elapses after the end of last PPDU contained in the EML Operating Mode Notification frame transmitted by the non-AP MLD— whichever occurs first.

After the non-AP MLD transitions into EMLMR mode, it is the AP MLD that sends an Initial Frame to the non-AP MLD. The subsequent EMLMR frame exchanges occur on the link on which the AP MLD sends the Initial Frame. According to the current specification, the AP MLD, for EMLMR frame exchanges, shall select one of the links that are included as the EMLMR links. According to the current specification, the Initial Frame can be any frame that is sent by the AP MLD to the non-AP MLD as the first frame after the non-AP MLD transitions into EMLMR mode.

After the AP MLD sends the Initial Frame on a link, the non-AP MLD is able to operate on that link with maximum spatial stream as indicated by the values in the EMLMR Rx NSS and EMLMR Tx NSS subfields in the EML Capabilities subfield of the Common Info field of the Basic Multi-Link element. Immediately after the EMLMR frame exchange sequence is complete, the STAs affiliated with the AP MLD go back to operating with the per-stream spatial capability.

FIG. 4 illustrates an example of EMLMR operation according to embodiments of the present disclosure. In this example, the AP MLD may be an AP MLD 101, and the non-AP MLD may be a non-AP MLD 111. Although the AP MLD 101 is illustrated with three affiliated APs (AP1, AP2, and AP3) and the non-AP MLD 111 is illustrated as a multi-radio non-AP MLD with three affiliated non-AP STAs (STA1, STA2, and STA3), it is understood that this process could be applied with suitable MLDs having any number of affiliated APs or STAs.

In the example of FIG. 4, the AP MLD has three affiliated APs: AP1 operating on 2.4 GHz band, AP2 operating on 5 GHz band, and AP3 operating on 6 GHz band. The non-AP MLD has three affiliated STAs: STA1 operating on 2.4 GHz band, STA2 operating on 5 GHz band, and STA3 operating on 6 GHz band. Three links are established between the AP MLD and the non-AP MLD: Link 1 between AP1 and STA1, Link 2 between AP2 and STA2, and Link 3 between AP3 and STA3. The non-AP MLD is a multi-radio non-AP MLD, where STA1, STA2, and STA3 each have two transmit chains and two receive chains. Both the AP MLD and the non-AP MLD support EMLMR operation. The non-AP AP MLD lists all three links—Link 1, Link 2, and Link 3—as the EMLMR links. In the Basic Multi-Link element exchanged between the AP MLD and the non-AP MLD, the EML Capabilities Present subfield is set to 1 and both the EMLMR Rx NSS and EMLMR Tx NSS subfields in the EML Capabilities subfield are set to the value of 4.

When the non-AP MLD intends to enter into EMLMR mode it sends an EML Operating Mode Notification frame 402 to the AP MLD on Link 2. In EML Operating Mode Notification frame 402, the EMLMR Mode subfield in the EML Control field is set to 1 and the EMLSR Mode subfield in the EML Control field is set to 0. Upon receiving the EML Operating Mode Notification frame 402 on Link 2, AP2 affiliated with the AP MLD sends, in response, another EML Operating Mode Notification frame 404 to the non-AP MLD on Link 2 and sets the EMLMR Mode subfield in the EML Control field to 1 and EMLSR Mode subfield in the EML Control field to 0 in the EML Operating Mode Notification frame 404.

Upon receiving the EML Operating Mode Notification frame 404 from the AP MLD, which is transmitted before the timeout timer indicated in the Transition Timeout subfield in the EML Capabilities subfield in the Basic Multi-Link element expires, the non-AP MLD transitions into EMLMR mode. After the non-AP MLD transitions into EMLMR mode, the AP MLD sends the Initial Frame 406 on Link 3 to initiate frame exchanges for EMLMR operation on Link 3.

Upon receiving the Initial Frame 406 on Link 3, the non-AP MLD transfers 1 transmit chain and 1 receive chain from Link 1 to Link 3, and transfers 1 transmit chain and 1 receive chain from Link 2 to Link 3. After the transmit and receive chain transfer process is complete, Link 3 has 4 transmit chains and 4 receive chains. Therefore, STA3 affiliated with the non-AP MLD can at this point perform transmit and receive operation using 4 spatial streams on Link 3, in accordance with the value set in the EMLMR Rx NSS and EMLMR Tx NSS subfields in the EML Capabilities subfield of the Basic Multi-link element. STA 3 affiliated with the non-AP MLD then sends an Ack frame in response to the initial control frame sent by the AP MLD. Accordingly, the AP MLD performs subsequent PPDU transmission to the non-AP MLD on Link 3 using 4 spatial streams.

As illustrated by the example of FIG. 4, for EMLMR mode operation, after the non-AP MLD transitions into EMLMR mode (by exchanging EML Operating Mode Notification frames with the associated AP MLD over any enabled link between the AP MLD and the non-AP MLD such that the EMLMR Mode subfield in the EML Control field of the exchanged EML Operating Mode Notification frame is set to 1), the non-AP MLD sends the Initial Frame to initiate the EMLMR frame exchanges on any EMLMR links. The subsequent EMLMR frame exchanges occur on the link on which the AP MLD sends the Initial Frame.

However, as discussed herein above, this process does not include a mechanism to indicate the EMLMR links and exchange this information between the AP MLD and the non-AP MLD supporting the EMLMR operation. Without an indication of the EMLMR links from the non-AP MLD, it is not possible for the AP MLD to know on which link to send the initial control frame to initiate the EMLMR frame exchanges. Embodiments of the present disclosure provided herein below facilitate EMLMR operation between an AP MLD and a non-AP MLD by providing mechanisms for exchanging information indicating which links are the EMLMR links.

According to one embodiment, when a non-AP MLD transitions into EMLMR mode, the EMLMR frame exchange can take place on any of the enabled links between the non-AP MLD and its associated AP MLD. According to this embodiment, all of the enabled links between the AP MLD and the non-AP MLD essentially become the EMLMR links. Therefore, based on this embodiment, once the non-AP MLD transitions into EMLMR mode, the AP MLD can send the initial frame on any enabled link between the AP MLD and the non-AP MLD to initiate the EMLMR frame exchange sequence.

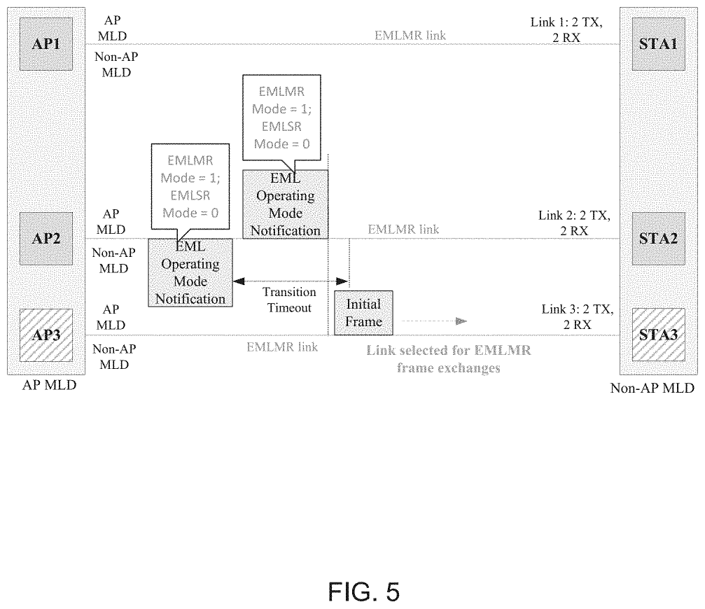

FIG. 5 illustrates an example of EMLMR operation when all links are treated as EMLMR links according to embodiments of the present disclosure. In the example of FIG. 5, the AP MLD has three affiliated APs: AP1 operating on 2.4 GHz band, AP2 operating on 5 GHz band, and AP3 operating on 6 GHz band. The non-AP MLD has three affiliated STAs: STA1 operating on 2.4 GHz band, STA2 operating on 5 GHz band, and STA3 operating on 6 GHz band. Three links are established between the AP MLD and the non-AP MLD: Link 1 between AP1 and STA1, Link 2 between AP2 and STA2, and Link 3 between AP3 and STA3. The non-AP MLD is a multi-radio non-AP MLD, where STA1, STA2, and STA3 each have two transmit chains and two receive chains. Both the AP MLD and the non-AP MLD support the EMLMR mode of operation.

All three enabled links (Link 1, Link 2, and Link 3) are the EMLMR links in this example. Accordingly, the AP MLD can select any of the three links for EMLMR frame exchanges. At one point in time in this example, the non-AP MLD intends to enter into EMLMR mode and sends an EML Operating Mode Notification frame to the AP MLD on Link 2. In that EML Operating Mode Notification frame, the EMLMR Mode subfield in the EML Control field is set to 1 and EMLSR Mode subfield in the EML Control field is set to 0.

Upon receiving the EML Operating Mode Notification frame on Link 2, AP2 affiliated with the AP MLD sends, in response, another EML Operating Mode Notification frame to the non-AP MLD on Link 2 and sets the EMLMR Mode subfield in the EML Control field to 1 and EMLSR Mode subfield in the EML Control field to 0 in the EML Operating Mode Notification frame. Upon receiving the EML Operating Mode Notification frame from the AP MLD, which is transmitted before the timeout timer indicated in the Transition Timeout subfield in the EML Capabilities subfield in the Basic Multi-Link element expires, the non-AP MLD transitions into EMLMR mode.

After the non-AP MLD transitions into EMLMR mode, the AP MLD sends the Initial Frame on Link 3 to initiate an EMLMR frame exchange. No explicit indication of the EMLMR links is needed for the AP MLD to select Link 3 for the EMLMR frame exchange in this example.

According to other embodiments, in order to operate in the EMLMR mode the EMLMR links need to be indicated explicitly. According to one such embodiment, the EMLMR links are a subset of setup links between the AP MLD and the non-AP MLD that support the EMLMR mode of operation. According to another embodiment, the EMLMR links are a subset of enabled links between the AP MLD and the non-AP MLD that support EMLMR mode of operation.

According to one embodiment, in order to operate in the EMLMR mode, the EMLMR links are indicated in the EML Operating Mode Notification frame by including an EMLMR Link Bitmap subfield in the EML Control field of the EML Operating Mode Notification frame exchanged between the AP MLD and the non-AP MLD.

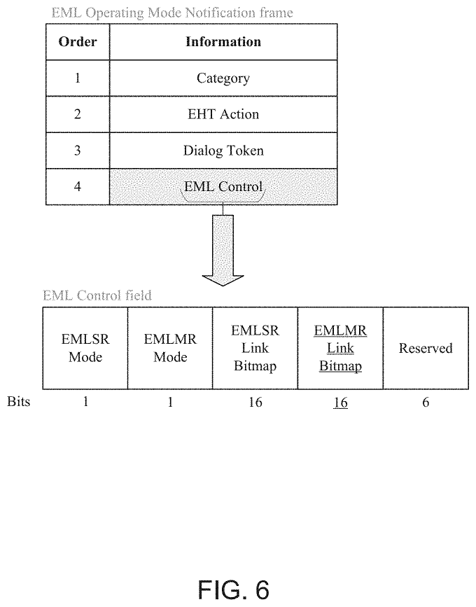

FIG. 6 illustrates an example format of the EML Control field including an EMLMR Link Bitmap subfield according to embodiments of the present disclosure. In the example of FIG. 6, the EMLMR Link Bitmap subfield in the EML Control field of the EML Operating Mode Notification frame indicates the subset of the enabled links that is used by the non-AP MLD in the EMLMR mode for EMLMR frame exchanges. The bit position i in the EMLMR Link Bitmap subfield corresponds to the link having Link ID equal to i, and is set to 1 to indicate that the link is used by the non-AP MLD for the EMLMR mode and is a member of the set of EMLMR links. Otherwise, the bit in this position is set to 0.

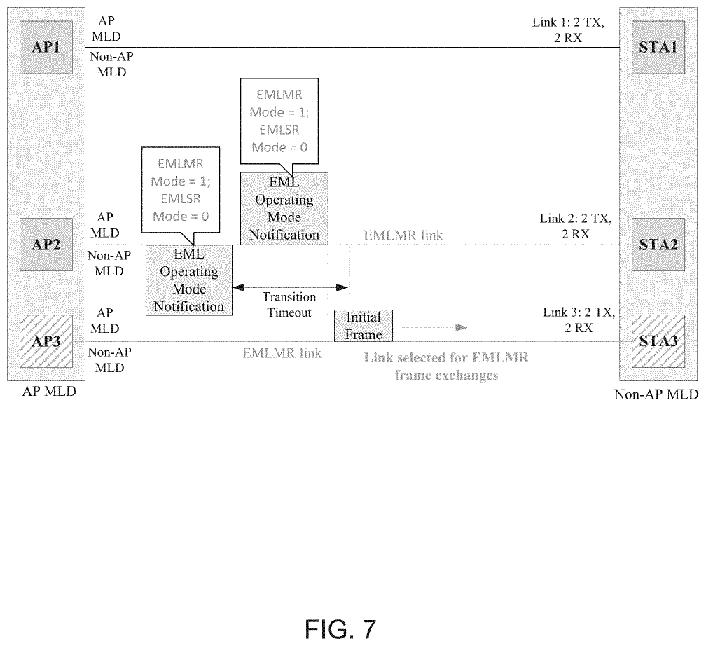

FIG. 7 illustrates an example of explicitly indicating EMLMR links for EMLMR frame exchanges according to embodiments of the present disclosure. The example of FIG. 7 uses the EML Operating Mode Notification frame format of FIG. 6.

In the example of FIG. 7, the AP MLD has three affiliated APs: AP1 operating on 2.4 GHz band, AP2 operating on 5 GHz band, and AP3 operating on 6 GHz band. The non-AP MLD has three affiliated STAs: STA1 operating on 2.4 GHz band, STA2 operating on 5 GHz band, and STA3 operating on 6 GHz band. Three links are established between the AP MLD and the non-AP MLD: Link 1 between AP1 and STA1, Link 2 between AP2 and STA2, and Link 3 between AP3 and STA3. The non-AP MLD is a multi-radio non-AP MLD, where STA1, STA2, and STA3 each have two transmit chains and two receive chains. Both the AP MLD and the non-AP MLD support the EMLMR mode of operation.

At one point in time in this example, the non-AP MLD intends to enter into EMLMR mode and sends an EML Operating Mode Notification frame to the AP MLD on Link 2. In that EML Operating Mode Notification frame, the EMLMR Mode subfield in the EML Control field is set to 1 and EMLSR Mode subfield in the EML Control field is set to 0. Moreover, the EMLMR Link Bitmap subfield in the EML Control field indicates the Link IDs of Link 2 and Link 3. Accordingly, the second bit and third bit of the EMLMR Link Bitmap subfield in the EML Control field are set to 1, and all other bits in the EMLMR Link Bitmap subfield are set to 0.

Upon receiving the EML Operating Mode Notification frame on Link 2, AP2 affiliated with the AP MLD sends, in response, another EML Operating Mode Notification frame to the non-AP MLD on Link 2 and sets the EMLMR Mode subfield in the EML Control field to 1 and EMLSR Mode subfield in the EML Control field to 0 in the EML Operating Mode Notification frame. In the EML Operating Mode Notification frame sent by the AP MLD, the EMLMR Link Bitmap subfield in the EML Control field also indicates the Link IDs of Link 2 and Link 3. Accordingly, the second bit and third bit of the EMLMR Link Bitmap subfield in the EML Control field sent by the AP MLD are set to 1, and all other bits in the EMLMR Link Bitmap subfield are set to 0.

Upon receiving the EML Operating Mode Notification frame from the AP MLD, which is transmitted before the timeout timer indicated in the Transition Timeout subfield in the EML Capabilities subfield in the Basic Multi-Link element expires, the non-AP MLD transitions into EMLMR mode. After the non-AP MLD transitions into EMLMR mode, the AP MLD sends the Initial Frame on Link 3 to initiate an EMLMR frame exchange.

With respect to the example of FIG. 6, according to another embodiment, if the EMLSR Mode subfield in the EML Control field of the EML Operating Mode Notification frame is set to 1 (and, accordingly, the EMLMR Mode subfield is set to 0), then the EMLMR Link Bitmap subfield is reserved. Similarly, if the EMLMR Mode subfield in the EML Control field of the EML Operating Mode Notification frame is set to 1 (and, accordingly, the EMLSR Mode subfield is set to 0), then then EMLSR Link Bitmap subfield is reserved in the EML Control field.

According to another embodiment of the example of FIG. 6, the sizes of the EMLSR Link Bitmap subfield and the EMLMR Link Bitmap subfield in the EML Control field of the EML Operating Mode Notification frame can be 8 bits long instead of 16 bits long.

According to one embodiment, the EMLMR Link Bitmap subfield can be conditionally present in the EML Control field of the EML Operating Mode Notification frame. According to this embodiment, the presence of the EMLMR Link Bitmap can be indicated by the EMLMR Link Bitmap Present subfield in the EML Control field.

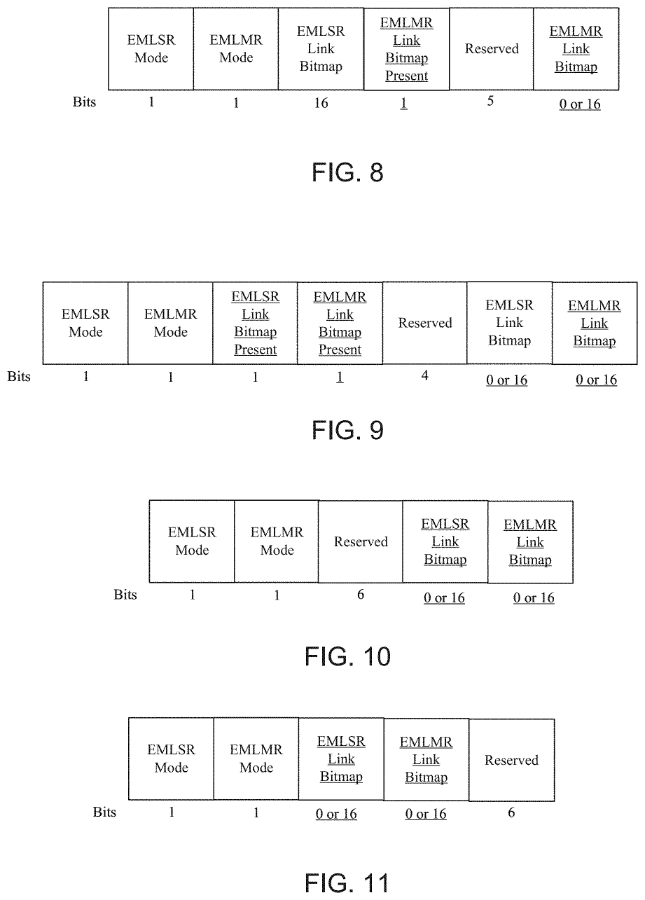

FIG. 8 illustrates an example format of the EML Control field including the EMLMR Link Bitmap subfield and the EMLMR Link Bitmap Present subfield according to embodiments of the present disclosure. In one embodiment, the EMLMR Link Bitmap subfield is present in the EML Control field of the EML Operating Mode Notification frame if the EMLMR Link Bitmap Present subfield is set to 1. Otherwise, the EMLMR Link Bitmap subfield is not present in the EML Control field of the EML Operating Mode Notification frame.

According to one embodiment of the example of FIG. 8, if the EMLMR Mode subfield is set to 1 (and, accordingly, the EMLSR Mode subfield is set to 0) but the EMLMR Link Bitmap Present subfield is set to 0, then it indicates that all enabled links between the AP MLD and the non-AP MLD are the EMLMR links.

According to another embodiment of the example of FIG. 8, if the EMLSR Mode subfield is set to 1 (and, accordingly, the EMLMR Mode subfield is set to 0), then the EMLMR Link Bitmap subfield in the EML Control field of the EML Operating Mode Notification frame is set to 0.

According to one embodiment, the EMLSR Link Bitmap subfield can also be conditionally present in the EML Control field of the EML Operating Mode Notification frame. According to this embodiment, the presence of the EMLSR Link Bitmap can be indicated by the EMLSR Link Bitmap Present subfield in the EML Control field.

FIG. 9 illustrates an example format of the EML Control field including both the EMLSR Link Bitmap Present subfield and the EMLMR Link Bitmap Present subfield according to embodiments of the present disclosure. The EMLMR Link Bitmap Present subfield of FIG. 9 may have the same function and structure as the EMLMR Link Bitmap Present subfield of FIG. 8.

According to one embodiment of FIG. 9, the EMLSR Link Bitmap subfield is present in the EML Control field of the EML Operating Mode Notification frame if the EMLSR Link Bitmap Present subfield is set to 1. Otherwise, the EMLSR Link Bitmap subfield is not present in the EML Control field of the EML Operating Mode Notification frame.

According to another embodiment of FIG. 9, if the EMLSR Mode subfield is set to 1 (and, accordingly, the EMLMR Mode subfield is set to 0) but the EMLSR Link Bitmap Present subfield is set to 0, then it indicates that all enabled links between the AP MLD and the non-AP MLD are the EMLSR links.

According to another embodiment of FIG. 9, if the EMLMR Mode subfield is set to 1 (and, accordingly, the EMLSR Mode subfield is set to 0), then the EMLSR Link Bitmap subfield in the EML Control field of the EML Operating Mode Notification frame is set to 0.

According to one embodiment, if the EMLSR Mode subfield in the EML Control field is set to 1, then the EMLSR Link Bitmap subfield is present in that EML Control field and the EMLMR Link Bitmap subfield is not present in that EML Control field. Similarly, if the EMLMR Mode subfield in the EML Control field is set to 1, then the EMLMR Link Bitmap subfield is present in that EML Control field and the EMLSR Link Bitmap subfield is not present in that EML Control field.

FIG. 10 illustrates another example format of the EML Control field according to embodiments of the present disclosure. In the example of FIG. 10, if the EMLSR Mode subfield in the EML Control field in the EML Operating Mode Notification frame is set to 1 (and, accordingly, the EMLMR Mode subfield is set to 0), then the EMLSR Link Bitmap subfield is present in the EML Control field and the EMLMR Link Bitmap subfield is not present in the EML Control field. According to another embodiment, if the EMLMR Mode subfield in the EML Control field in the EML Operating Mode Notification frame is set to 1 (and, accordingly, the EMLSR Mode subfield is set to 0), then the EMLMR Link Bitmap subfield is present in the EML Control field and the EMLSR Link Bitmap subfield is not present in the EML Control field.

With respect to FIGS. 6 and 11-13, the positions of the subfields in the corresponding EML Control field can vary. For example, with reference to FIG. 10, the Reserved bits can be the last set of bits in the EML Control field.

FIG. 11 illustrates another example format of the EML Control field according to embodiments of the present disclosure. The format of the EML Control field of FIG. 11 is similar to the format of the EML Control field of FIG. 10, except that the Reserved bits are moved to the end of the EML Control field.

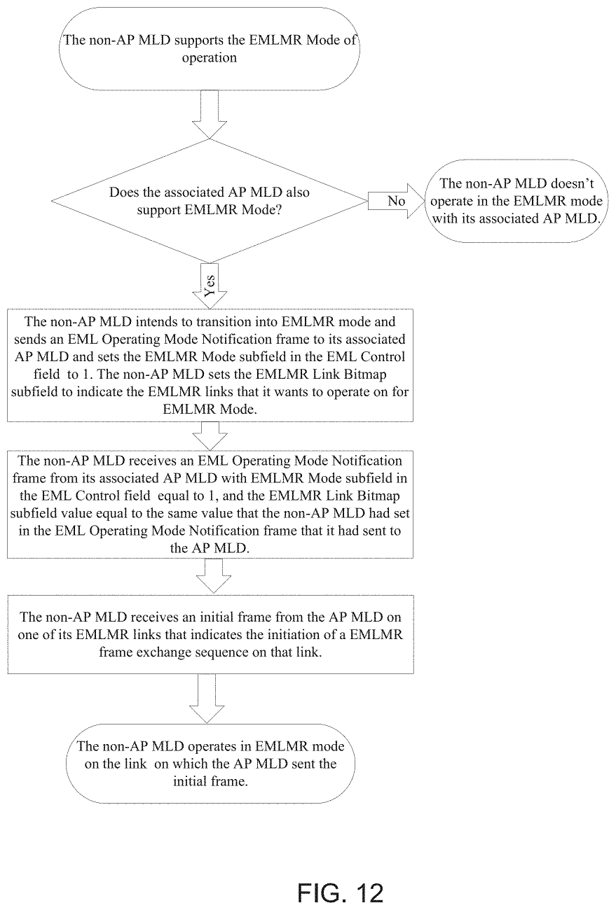

FIG. 12 illustrates an example process using the EMLMR Link Bitmap subfield in order to indicate the EMLMR links according to embodiments of the present disclosure. The process of FIG. 12 may be used, for example with the frame formats of FIGS. 6 and 8-11.

According to some embodiments, the EMLMR links can be indicated in the transmitted Basic Multi-Link element. According to one such embodiment, in order to make such an indication, an EMLMR Link Bitmap subfield is included in the EML Capabilities subfield of the Common Info field of the transmitted Basic Multi-Link element.

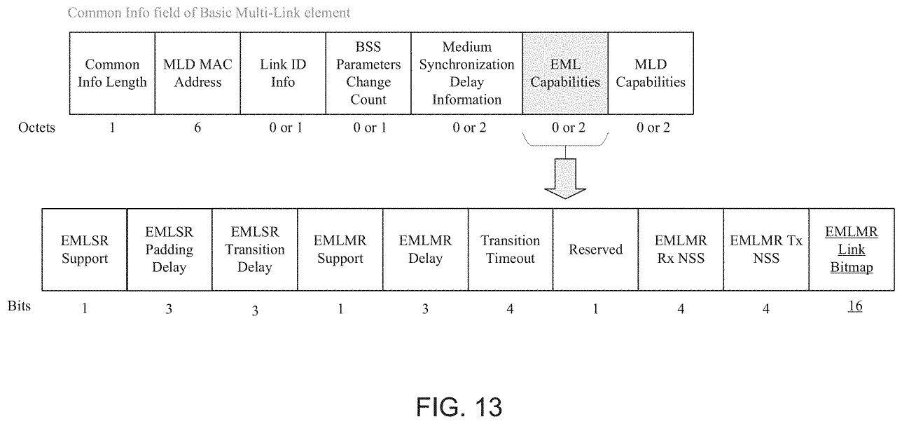

FIG. 13 illustrates an example format of the EML Capabilities subfield of the Common Info field of the Basic Multi-Link element according to embodiments of the present disclosure. In one embodiment of FIG. 13, the EMLMR Link Bitmap subfield in the EML Capabilities subfield of the Common Info field of the Basic Multi-Link element indicates the subset of the enabled links that is used by the non-AP MLD in the EMLMR mode for EMLMR frame exchanges. The bit position i in the EMLMR Link Bitmap subfield corresponds to the link having Link ID equal to i, and is set to 1 to indicate that the corresponding link is used by the non-AP MLD for the EMLMR mode and is a member of the set of EMLMR links. Otherwise, the bit position is set to 0.

According to various embodiments provided herein, the EMLMR Link Bitmap subfield can be included in either the EML Operating Mode Notification frame or the Common Info field. An advantage of including the EMLMR Link Bitmap subfield in the EML Operating Mode Notification frame is that this frame is tailored for devices that can perform EML operations, and only the devices that are currently operating in the EMLMR mode will receive the EMLMR link bitmap information. An advantage of including the EMLMR Link Bitmap subfield in the Common Info field is that the information will be readily available since all EHT devices are able to decode the Basic Multi-Link element.

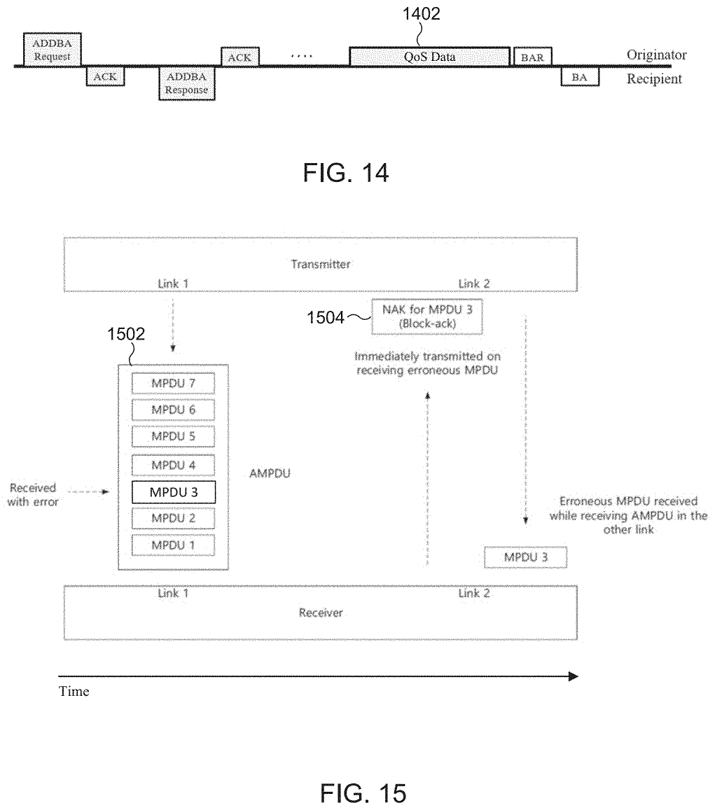

FIG. 14 illustrates an example of single-link BA agreement setup, data transfer, and acknowledgement according to embodiments of the present disclosure. In this example, the originator (or transmitter) may be an AP, and the recipient (or receiver) may be a STA. In the example of FIG. 14, the originator sets up protected BA by sending an ADDBA Request frame, and the recipient responds with the ADDBA Response frame after validating the ADDBA Request frame and updating its windows. The originator updates its windows after receiving the ADDBA Response frame. Once the protected BA is set up, the originator can transmit QoS Data 1402 in an A-MPDU. A BAR/BA exchange is then used to validate reception status.

As discussed herein above, ML-BA operation brings benefits over non-ML BA (i.e., single-link BA) for large buffer data as it allows transmission of the BA on any of the enabled links, however, since retransmission of failed MPDUs of the A-MPDU is allowed on any of the enabled links that have the same TIDs mapped to them, and the retransmission will not start until the ML-BA is received by the originator, which is after the A-MPDU and BAR are received by the recipient, MLO may not be utilized efficiently to enhance retransmission compared to single-link BA operation.

Accordingly, as also discussed herein above, a QR mode may be used with ML-BA, utilizing a DL to carry QoS data from originator to recipient and a QRL (or QCL) to carry a failed MPDU indication from recipient to originator and carries the retransmission of the one or more failed MPDUs from the originator to the recipient. TXOPs on both links are utilized for a single A-MPDU transmission as opposed to transmitting two or more different A-MPDUs on the same links.

FIG. 15 illustrates an example of Quick Recovery mode operation for MLO according to embodiments of the present disclosure. In this example, the transmitter (or originator) may be an AP MLD, such as AP MLD 101, and the receiver (or recipient) may be a non-AP MLD, such as non-AP MLD 111. Furthermore, although two links (Link 1 and Link 2) are shown between the transmitter and the receiver, it is understood that this process could be applied with any number of suitable MLDs having any number of affiliated APs or STAs.

In the example of FIG. 15, MPDU 3 of the A-MPDU 1502 is received by the receiver on Link 1 with an error. MPDU 3 may alternatively be referred to as a failed MPDU, a failing MPDU, an MPDU that was not received or not received correctly, or in any other suitable manner. The receiver determines that MPDU 3 was not received correctly while it is still receiving the A-MPDU 1502. In response to this determination, the receiver transmits a negative acknowledgement (NACK) 1504 for MPDU 3 to the transmitter over Link 2, while the receiver simultaneously continues receiving the A-MPDU 1502 on Link 1. The NACK 1504 may be a BA frame, such as the QR-BA frame discussed further below. The transmitter, upon receiving the NACK 1504, retransmits MPDU 3 on Link 2 (or any other enabled link) while it simultaneously continues transmitting the A-MPDU 1502 on Link 1. This results in an improvement in total transmission time of an A-MPDU.

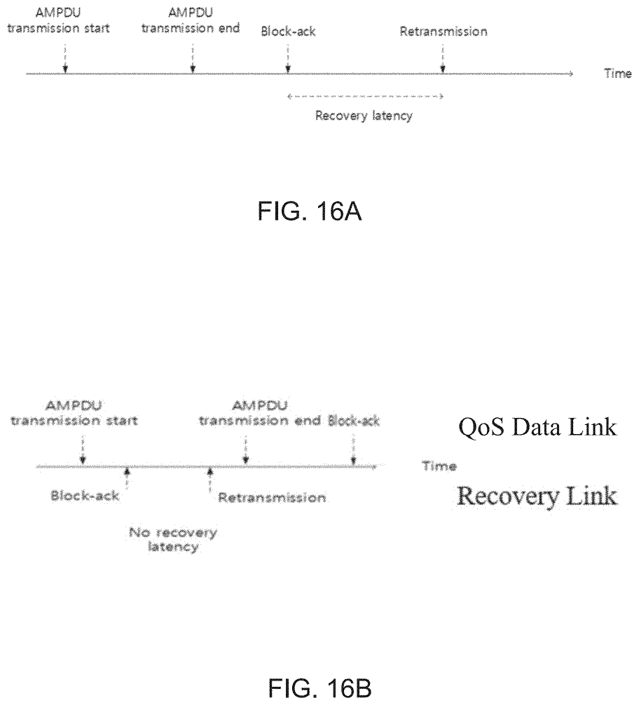

FIGS. 16A and 16B illustrate the improvement in total transmission time of an A-MPDU that is gained QR methods according to embodiments of the present disclosure.

FIG. 16A illustrates an example timing for A-MPDU transmission using ML-BA without QR mode operation according to embodiments of the present disclosure. In this example, because the receiver must wait until the A-MPDU has finished transmitting to send a BA that includes an indication of failed MPDUs from the A-MPDU, there is recovery latency incurred between the completion of the A-MPDU transmission and the retransmission of failed MPDUs.

FIG. 16B illustrates an example timing for A-MPDU transmission using ML-BA with QR mode operation according to embodiments of the present disclosure. In this example, because the MLDs are able to utilize the QRL during transmission of the A-MPDU on the QoS data link, the receiver is able to transmit a BA (e.g., a QR-BA) on the QRL including an indication of failed MPDUs from the A-MPDU before the A-MPDU has finished transmitting on the QoS data link, and likewise the transmitter is able to retransmit the failed MPDUs on the QRL before the A-MPDU has finished transmitting on the QoS data link. As a result, there is no recovery latency incurred—the retransmission of failed MPDUs is completed before the BA for the A-MPDU is sent.

Referring again to FIG. 15, the QRL may lose channel access as it is silent for most of the TXOP, and is only active when it is retransmitting failed MPDUs (e.g., MPDU 3) from the other link. As a result, there is a risk of losing the TXOP when other STAs listen to the channel and find it clear during a clear channel assessment (CCA). Accordingly, embodiments of the present disclosure herein below provide mechanisms that allow an MLD to avoid losing the TXOP on the QCL.

According to one embodiment, use of request to send (RTS) is mandated to update network allocation vector (NAV) timers for STAs in the basic service set (BSS) while NAV timer will carry the same information of the timer for the QoS data carrying link (e.g., the DL).

According to another embodiment, the QRL can repeat transmissions of the same QoS data transmitted on the DL in single MPDUs (not A-MPDUs) until a failure occurs at the recipient, at which point the QRL can be used for retransmission of the failed MPDUs. Afterwards, the QRL resumes repeating the transmissions of the DL.

According to another embodiment, the QRL can also transmit new MPDUs from the same buffer in single MPDUs without using BA (so that it can stop at any time to support recovery of another link). This follows conventional ML operation whereby data can be transmitted over multiple links.

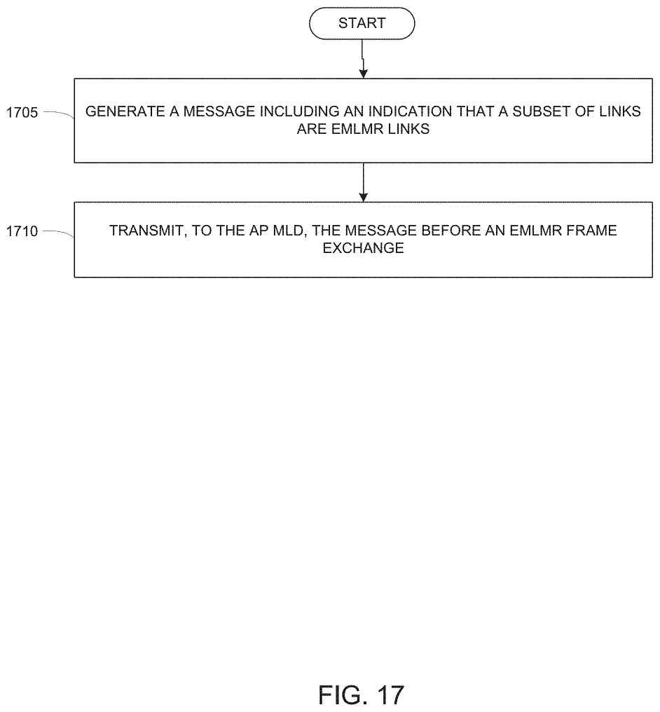

FIG. 17 illustrates an example process for facilitating the indication of links of an MLD that are configured for EMLMR operation according to various embodiments of the present disclosure. The process of FIG. 17 is discussed as being performed by a non-AP MLD, but it is understood that a corresponding AP MLD performs a corresponding process. Additionally, for convenience the process of FIG. 17 is discussed as being performed by a WI-FI non-AP MLD comprising a plurality of STAs that each comprise a transceiver configured to configured to form a link with a corresponding AP affiliated with a WI-FI AP MLD, wherein at least a subset of the links are EMLMR links configured to operate in an EMLMR mode of operation. However, it is understood that any suitable wireless communication device could perform these processes.

Referring to FIG. 17, the process begins with the non-AP MLD generating a message including an indication that the subset of the links are EMLMR links (step 1705). This message may be generated with various formats according to various embodiments of the present disclosure.

In some embodiments, the message may be an EML operating mode notification frame that indicates link IDs of the EMLMR links. In one such embodiment, the EML operating mode notification frame includes an EML control field that includes an EMLMR link bitmap subfield, and the EMLMR link bitmap subfield indicates which of the links are the EMLMR links. In another such embodiment, the EML operating mode notification frame includes an EML control field that includes an EMLMR link bitmap subfield presence indicator that indicates whether the EML control field includes an EMLMR link bitmap subfield indicating which of the links are the EMLMR links. The EML control field in this case may further include an EMLMR mode indicator that is set to indicate that the non-AP MLD intends to operate in the EMLMR mode, and the EMLMR link bitmap subfield presence indicator may be set to indicate that the EML control field does not include the EMLMR link bitmap subfield as an indication that all of the links are EMLMR links.

In some embodiments, the message may be an EML operating mode notification frame that does not explicitly include link IDs of the EMLMR links. Rather, the EML operating mode notification frame itself may serve as an indication that all of the links are EMLMR links.

In yet other embodiments, the message may be a basic multi-link element that indicates link IDs of the EMLMR links.

After generating the message at step 1705, the non-AP MLD transmits, to the AP MLD, the message before an EMLMR frame exchange (step 1710).

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A non-access point (AP) multi-link device (MLD), comprising:
stations (STAs), each comprising a transceiver configured to form a link with a corresponding AP of an AP MLD, wherein at least a subset of the links are enhanced multi-link multi-radio (EMLMR) links configured to operate in an EMLMR mode of operation; and
a processor operably coupled to the STAs, the processor configured to generate a message including an indication that the subset of the links are EMLMR links,
wherein at least one of the transceivers is further configured to transmit, to the AP MLD, the message before an EMLMR frame exchange.

2. The non-AP MLD of claim 1, wherein the processor is configured to generate the message as an enhanced multi-link (EML) operating mode notification frame that indicates link identifiers (IDs) of the EMLMR links.

3. The non-AP MLD of claim 2, wherein:
the EML operating mode notification frame includes an EML control field that includes an EMLMR link bitmap subfield, and
the EMLMR link bitmap subfield indicates which of the links are the EMLMR links.

4. The non-AP MLD of claim 2, wherein the EML operating mode notification frame includes an EML control field that includes an EMLMR link bitmap subfield presence indicator that indicates whether the EML control field includes an EMLMR link bitmap subfield indicating which of the links are the EMLMR links.

5. The non-AP MLD of claim 4, wherein:
the EML control field further includes an EMLMR mode indicator that is set to indicate that the non-AP MLD intends to operate in the EMLMR mode, and
the EMLMR link bitmap subfield presence indicator is set to indicate that the EML control field does not include the EMLMR link bitmap subfield as an indication that all of the links are EMLMR links.

6. The non-AP MLD of claim 1, wherein:
the processor is configured to generate the message as an EML operating mode notification frame, and
the EML operating mode notification frame serves as an indication that all of the links are EMLMR links.

7. The non-AP MLD of claim 1, the processor is configured to generate the message as a basic multi-link element that indicates link IDs of the EMLMR links.

8. An access point (AP) multi-link device (MLD), comprising:
APs, each comprising a transceiver configured to form a link with a corresponding station (STA) of a non-AP MLD, wherein at least one of the transceivers is configured to receive, from the non-AP MLD, a message including an indication that at least a subset of the links are enhanced multi-link multi-radio (EMLMR) links configured to operate in an EMLMR mode of operation; and
a processor operably coupled to the APs, the processor configured to select one of the EMLMR links on which to initiate an EMLMR frame exchange.

9. The AP MLD of claim 8, wherein the message is an enhanced multi-link (EML) operating mode notification frame that indicates link identifiers (IDs) of the EMLMR links.

10. The AP MLD of claim 9, wherein:
the EML operating mode notification frame includes an EML control field that includes an EMLMR link bitmap subfield, and
the EMLMR link bitmap subfield indicates which of the links are the EMLMR links.

11. The AP MLD of claim 9, wherein the EML operating mode notification frame includes an EML control field that includes an EMLMR link bitmap subfield presence indicator that indicates whether the EML control field includes an EMLMR link bitmap subfield indicating which of the links are the EMLMR links.

12. The AP MLD of claim 11, wherein:
the EML control field further includes an EMLMR mode indicator that is set to indicate that the non-AP MLD intends to operate in the EMLMR mode, and
the EMLMR link bitmap subfield presence indicator is set to indicate that the EML control field does not include the EMLMR link bitmap subfield as an indication that all of the links are EMLMR links.

13. The AP MLD of claim 8, wherein:
the message is an EML operating mode notification frame, and
the EML operating mode notification frame serves as an indication that all of the links are EMLMR links.

14. The AP MLD of claim 8, wherein the message is a basic multi-link element that indicates link IDs of the EMLMR links.

15. A method of wireless communication performed by a non-access point (AP) multi-link device (MLD) that comprises stations (STAs) that each comprise a transceiver configured to form a link with a corresponding AP of an AP MLD, at least a subset of the links being enhanced multi-link multi-radio (EMLMR) links configured to operate in an EMLMR mode of operation, the method comprising:
generating a message including an indication that the subset of the links are EMLMR links; and
transmitting, to the AP MLD, the message before an EMLMR frame exchange.

16. The method of claim 15, further comprising generating the message as an enhanced multi-link (EML) operating mode notification frame that indicates link identifiers (IDs) of the EMLMR links.

17. The method of claim 16, wherein:
the EML operating mode notification frame includes an EML control field that includes an EMLMR link bitmap subfield, and
the EMLMR link bitmap subfield indicates which of the links are the EMLMR links.

18. The method of claim 16, wherein the EML operating mode notification frame includes an EML control field that includes an EMLMR link bitmap subfield presence indicator that indicates whether the EML control field includes an EMLMR link bitmap subfield indicating which of the links are the EMLMR links.

19. The method of claim 18, wherein:
the EML control field further includes an EMLMR mode indicator that is set to indicate that the non-AP MLD intends to operate in the EMLMR mode, and
the EMLMR link bitmap subfield presence indicator is set to indicate that the EML control field does not include the EMLMR link bitmap subfield as an indication that all of the links are EMLMR links.

20. The method of claim 15, further comprising:
generating the message as an EML operating mode notification frame,
wherein the EML operating mode notification frame serves as an indication that all of the links are EMLMR links.
